(19) United States
(12) Patent Application Publication
(10) Pub. No.: US 2018/0180120 A1
(43) Pub. Date: Jun. 28, 2018

(54) BRAKE MODULE

(71) Applicant: TOYOTA JIDOSHA KABUSHIKI KAISHA, Toyota-shi (JP)

(72) Inventor: Tomohiro YOKOYAMA, Toyota-shi (JP)

(73) Assignee: TOYOTA JIDOSHA KABUSHIKI KAISHA, Toyota-shi (JP)

(21) Appl. No.: 15/835,625

(22) Filed: Dec. 8, 2017

(30) Foreign Application Priority Data
Dec. 22, 2016 (JP) 2016-249866

(51) Int. Cl. F16D 65/095; F16D 65/00; F16D 55/226

(52) U.S. Cl. CPC F16D 65/095; F16D 55/226; F16D 65/0056; F16D 65/0068

(57) ABSTRACT

In a brake module, a pad support member includes a first extended portion and a second extended portion. The first extended portion extends from a portion of the first extended portion, fixed to a bracket, toward an outer side in a disc rotor radial direction. The second extended portion extends from a predetermined portion of the first extended portion toward both sides along a disc rotor tangential direction. A pad of the brake module has a cutout having a shape corresponding to the second extended portion, and, at the time when the pad is brought into contact with a rotating disc rotor, the second extended portion is fitted to the cutout.

### INCORPORATION BY REFERENCE

The disclosure of Japanese Patent Application No. 2016-249866 filed on Dec. 22, 2016 including the specification, drawings and abstract is incorporated herein by reference in its entirety.

### BACKGROUND

### 1. Technical Field

The disclosure relates to a brake module.

### 2. Description of Related Art

There is known a brake module for a vehicle. The brake module includes a disc rotor, a pad and a piston. The disc rotor is configured to be rotatable about its axis. The pad is provided opposite the disc rotor in an axial direction parallel to the axis. The piston is used to bring the pad into contact with the disc rotor by pressing the pad. Japanese Patent Application Publication No. 2011-241951 (JP 2011-241951 A) describes a brake module. In the brake module, each pad is supported by a caliper via two support shafts so as to be movable in a rotor axial direction. The two support shafts include a single inner periphery support shaft and an outer periphery support shaft. The inner periphery support shaft is provided integrally with the caliper, and is engaged with a V-shaped inner peripheral torque bearing surface at two locations on the inner side of each lining in a rotor radial direction at the center of the lining in a rotor circumferential direction. The V-shaped inner peripheral torque bearing surface is provided in each back plate. The outer periphery support shaft is provided integrally with the caliper, and is engaged with an outer peripheral torque bearing surface at one location on the outer side of each lining in the rotor radial direction at the center of the lining in the rotor circumferential direction. The outer peripheral torque bearing surface is provided in each back plate.

### SUMMARY

In JP 2011-241951 A, with the brake module configured as described above, the behavior of each pad is stable during braking, with the result a reduction of brake squeal resulting from an unstable behavior of the pad during braking. However, the brake module described in JP 2011-241951 A has a larger number of components for holding the pads, so there is an inconvenience in terms of weight reduction. In addition, with the brake module described in JP 2011-241951 A, when the pads have partial wear, or the like, the behavior of the pads is sometimes not sufficiently stable at the time when the pads have been brought into contact with a rotating disc rotor.

The disclosure provides a brake module that is able to improve noise vibration performance by stabilizing the behavior of a pad at the time when the pad has been brought into contact with a rotating disc rotor without increasing the number of components.

An aspect of the disclosure provides a brake module. The brake module includes a disc rotor rotatable about an axis of the disc rotor; a pad arranged opposite the disc rotor in an axial direction of the disc rotor, the pad being configured to exert braking force at a time when the pad is in contact with the disc rotor; a piston configured to bring the pad into contact with the disc rotor by pressing the pad; a bracket supporting the piston such that the piston is movable in the axial direction; and a pad support member supporting the pad such that the pad does not rotate at a time when the pad is brought into contact with the rotating disc rotor. The pad support member includes a first extended portion and a second extended portion. The first extended portion extends from a portion at which the first extended portion is fixed to the bracket, toward an outer side in a disc rotor radial direction. The second extended portion extends from a predetermined portion of the first extended portion toward both sides along a disc rotor tangential direction. The pad has a cutout having a shape corresponding to the second extended portion. The second extended portion is configured to be fitted to the cutout at the time when the pad is brought into contact with the rotating disc rotor.

The pad support member includes the first extended portion and the second extended portion. The first extended portion extends from the portion, fixed to the bracket, toward the outer side in the disc rotor radial direction. The second extended portion extends from the predetermined portion of the first extended portion toward both sides along the disc rotor tangential direction. The pad has the cutout having a shape corresponding to the second extended portion. As the pad is brought into contact with the disc rotor when the disc rotor is rotating in the forward direction or rotating in the reverse direction, a force toward one side or the other side in the disc rotor tangential direction or a force toward the outer side or inner side in the disc rotor radial direction is exerted on the pad. At the time when the pad has been brought into contact with the rotating disc rotor, the above-described forces exerted on the pad are born by fitting the second extended portion of the pad support member to the cutout of the pad, so it is possible to inhibit rotation of the pad. Thus, since the behavior of the pad at the time when the pad has been brought into contact with the rotating disc rotor is stable, it is possible to improve noise vibration performance. Since the first extended portion just needs to be extended from the portion fixed to the bracket and the second extended portion just needs to be extended from the first extended portion, an increase in the number of components is not required.

In the above aspect, the brake module may further include an urging member inserted between an outer end face of the second extended portion on the outer side in the disc rotor radial direction and a first side face of the cutout. The urging member may be configured to urge the pad toward the outer side in the disc rotor radial direction such that a second side face of the cutout contacts an inner end face of the second extended portion on an inner side in the disc rotor radial direction.

The urging member is inserted between the outer end face of the second extended portion on the outer side in the disc rotor radial direction and the first side face of the cutout (a face of the cutout, opposite the outer end face), and urges the pad toward the outer side in the disc rotor radial direction. With this urging member, the second side face of the cutout (a face of the cutout, opposite the inner end face) is constantly in contact with the inner end face of the second extended portion on the inner side in the disc rotor radial direction. Thus, it is possible to further improve noise vibration performance by further stabilizing the behavior of the pad at the time when the pad has been brought into contact with the rotating disc rotor.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a perspective view that shows the appearance of a brake module according to a first embodiment;

FIG. 2 is a perspective view in which a housing having a cylinder is omitted from the brake module shown in FIG. 1;

FIG. 3 is a front view in which an outer pad is further omitted from the brake module shown in FIG. 2, from which the housing is omitted, when viewed along the arrow A in FIG. 2, that is, a direction parallel to an axial direction;

FIG. 4 is a perspective view that shows a bracket and a pad support member in the brake module according to the first embodiment;

FIG. 5 is a perspective view that shows an inner pad in the brake module according to the first embodiment;

FIG. 6 is a schematic view that illustrates forces exerted on the inner pad at the time when the inner pad has been brought into contact with the disc rotor when a vehicle is moving forward;

FIG. 7 is a schematic view that illustrates forces exerted on the inner pad at the time when the inner pad has been brought into contact with the disc rotor when the vehicle is moving backward;

FIG. 8 is a view, corresponding to FIG. 3 of the first embodiment, in a second embodiment;

FIG. 9 is a perspective view that shows a leaf spring in a brake module according to the second embodiment; and

FIG. 10 is a perspective view that shows an inner pad in the brake module according to the second embodiment.

### DETAILED DESCRIPTION OF EMBODIMENTS

### First Embodiment

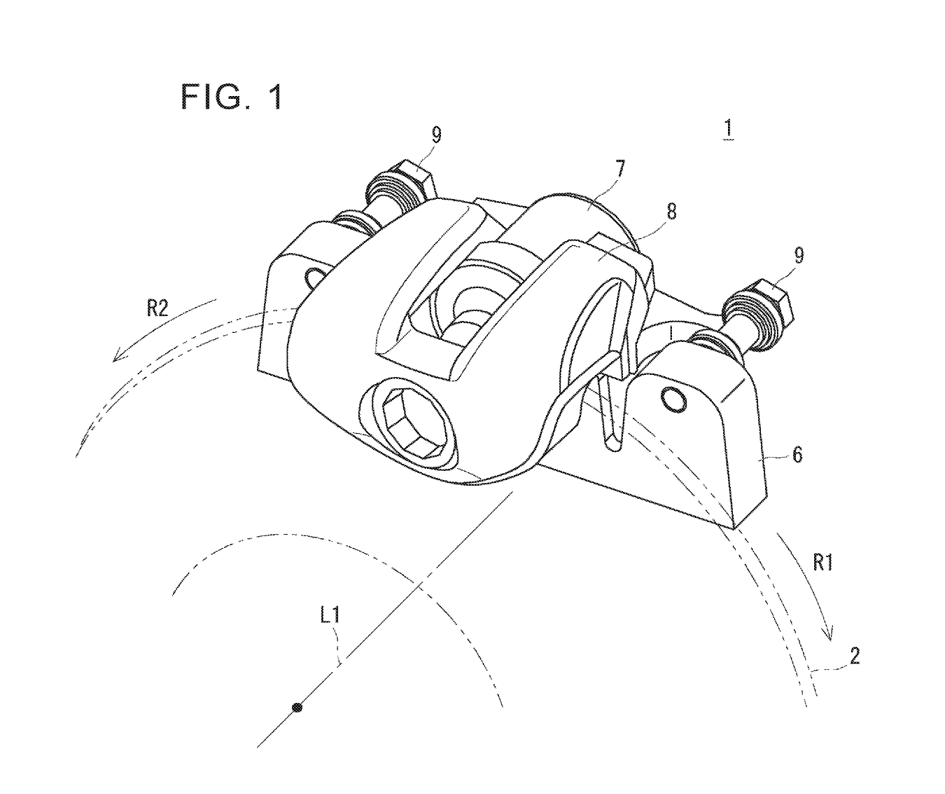

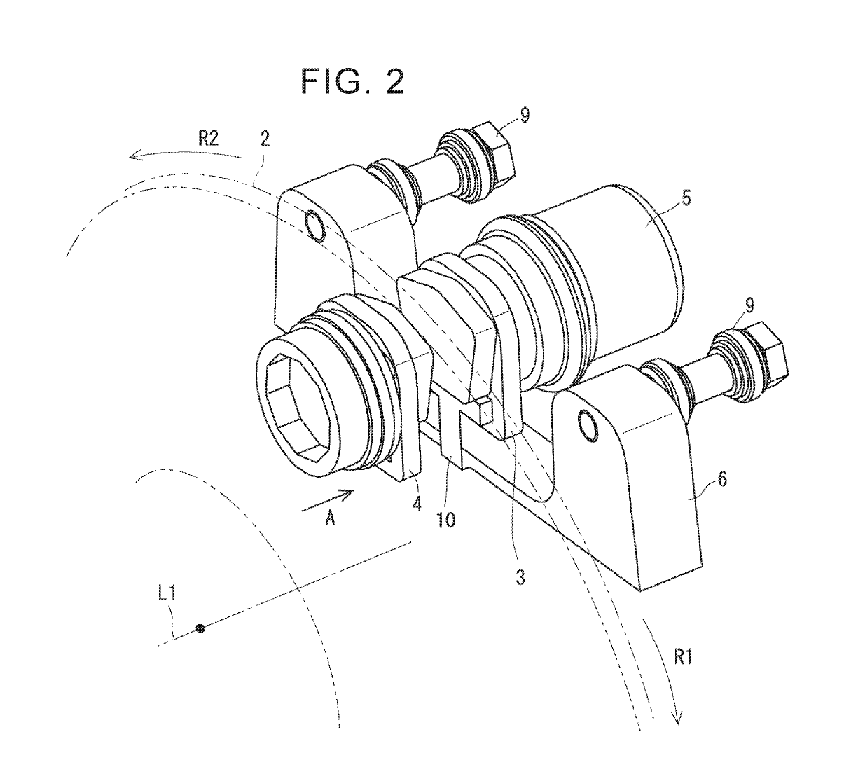

Hereinafter, a first embodiment of the disclosure will be described with reference to the accompanying drawings. The configuration of a brake module 1 for a vehicle according to the present embodiment will be described with reference to FIG. 1 and FIG. 2. FIG. 1 is a perspective view that shows the appearance of the brake module 1 according to the present embodiment. FIG. 2 is a perspective view in which a housing 8 having a cylinder 7 is omitted from the brake module 1 shown in FIG. 1. As shown in FIG. 1 and FIG. 2, the brake module 1 includes a disc rotor 2, an inner pad 3 that serves as a pad, a piston 5, a bracket 6 and a pad support member 10.

The disc rotor 2 is a disc-shaped member, and is configured to be rotatable about an axis L1 together with an axle in a vehicle. The disc rotor 2 rotates in the direction of the arrow R1 (rotates in a forward direction) when the vehicle moves forward, and rotates in the direction of the arrow R2 (rotates in a reverse direction) when the vehicle moves backward. The inner pad 3 is arranged opposite the disc rotor 2 in an axial direction along the axis L1, and exerts braking force at the time when the inner pad 3 is in contact with the disc rotor 2. The details of the structure of the inner pad 3 will be described later.

The pad support member 10 supports the inner pad 3 such that the inner pad 3 does not rotate at the time when the inner pad 3 has been brought into contact with the rotating disc rotor 2. The details of the structure of the pad support member 10 will be described later.

The piston 5 is used to bring the inner pad 3 into contact with the disc rotor 2 by pressing the inner pad 3. The bracket 6 supports the piston 5 such that the piston 5 is movable in the axial direction. Specifically, the housing 8 is attached to the bracket 6 by slide pins 9. The piston 5 is assembled to the cylinder 7 of the housing 8 in a fluid-tight manner such that the piston 5 is slidable in the axial direction along the axis L1.

A fluid chamber defined so as to be surrounded by the cylinder 7 and the piston 5 in a fluid-tight manner is filled with brake oil. As the fluid pressure of brake oil filled in the fluid chamber is increased, the piston 5 moves so as to press the inner pad 3, and the inner pad 3 contacts the disc rotor 2. As the inner pad 3 contacts the disc rotor 2, friction force is generated between the inner pad 3 and the disc rotor 2, so the rotating disc rotor 2 is decelerated or stopped.

In the brake module 1, an outer pad 4 is arranged at a position on the other side in the axial direction with respect to a position of the disc rotor 2 opposite the inner pad 3. The outer pad 4 is attached to the housing 8 supported by the bracket 6. As the inner pad 3 contacts the disc rotor 2 as a result of movement of the piston 5, the outer pad 4 also contacts the disc rotor 2. As the outer pad 4 contacts the disc rotor 2, friction force is generated between the outer pad 4 and the disc rotor 2 to decelerate or stop the rotating disc rotor 2. That is, the rotating disc rotor 2 is held between the inner pad 3 and the outer pad 4 to be decelerated or stopped.

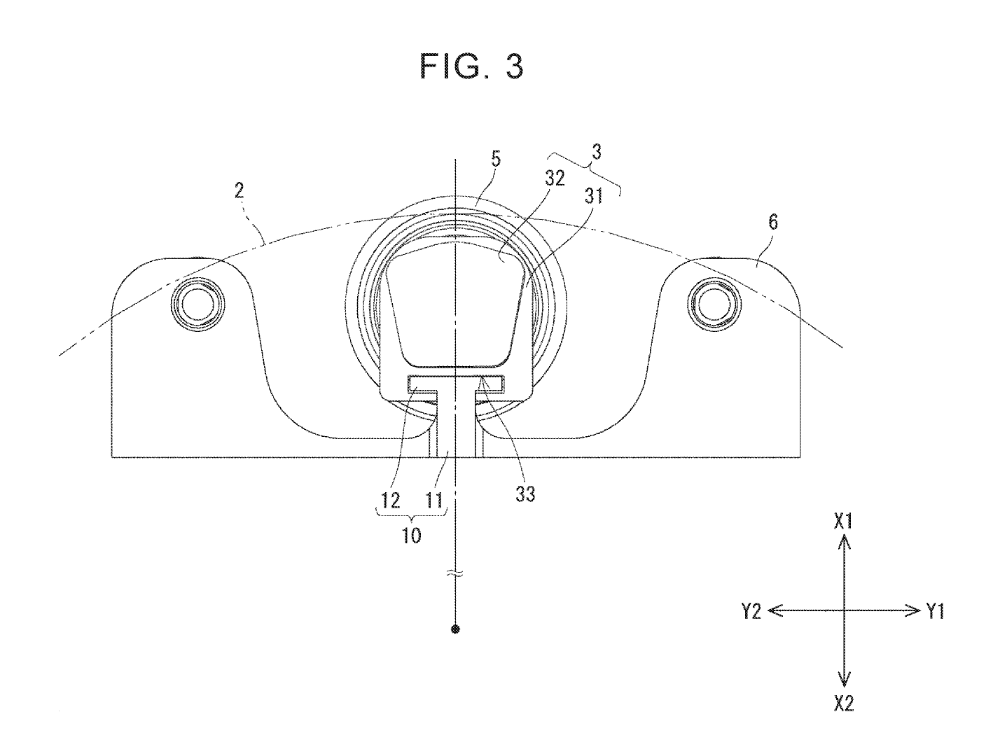

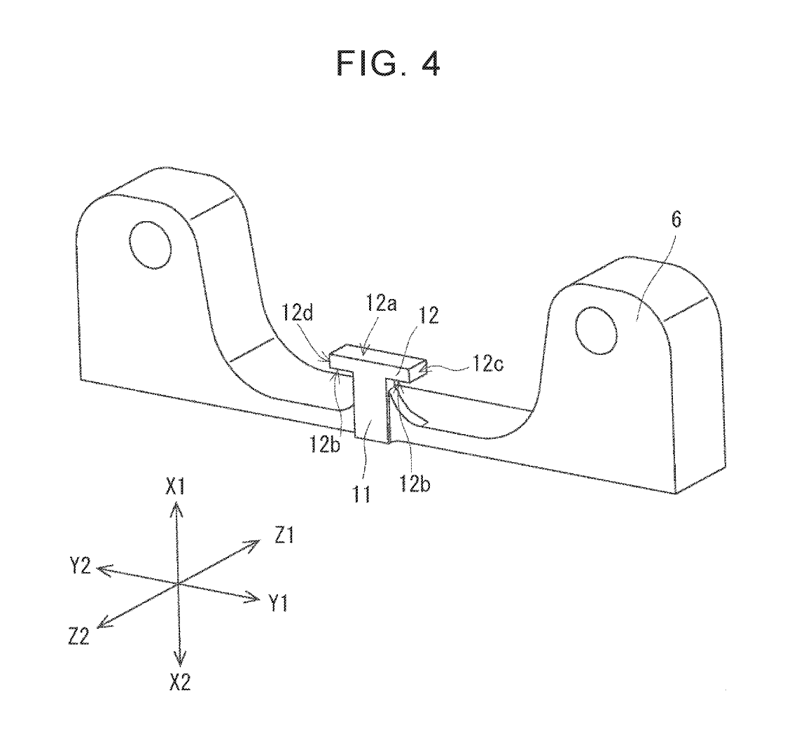

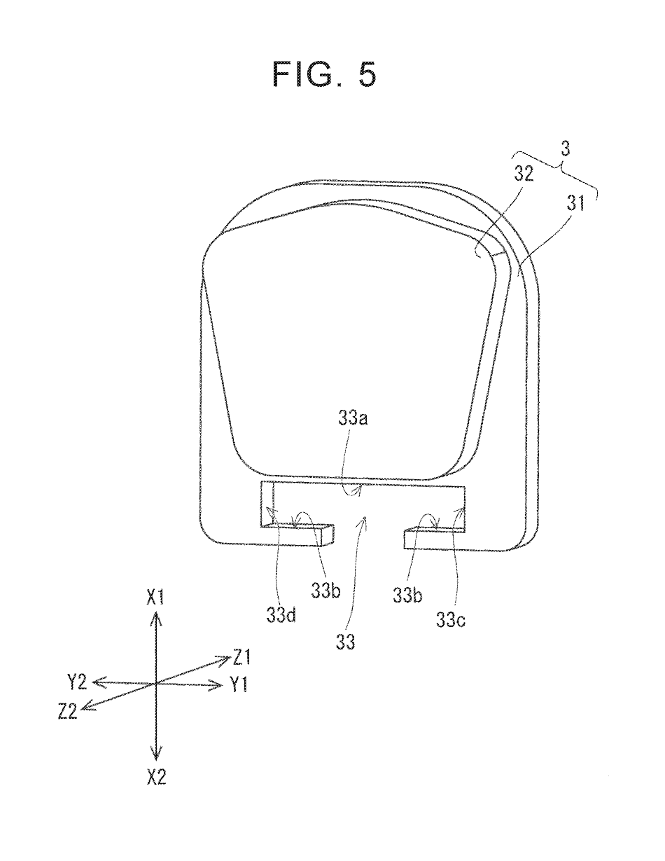

Next, the details of the structures of the pad support member 10 and inner pad 3 will be described. FIG. 3 is a front view in which the outer pad 4 is further omitted from the brake module 1 shown in FIG. 2, from which the housing 8 is omitted, when viewed in a direction parallel to the axial direction (arrow A in FIG. 2). FIG. 4 is a perspective view that shows the bracket 6 and the pad support member 10 in the brake module 1. FIG. 5 is a perspective view that shows the inner pad 3 in the brake module 1. The arrow X1 indicates a direction toward an outer side in a disc rotor radial direction. The arrow X2 indicates a direction toward an inner side in the disc rotor radial direction. The arrow Y1 indicates a direction toward one side in a disc rotor tangential direction. The arrow Y2 indicates a direction toward the other side in the disc rotor tangential direction. The arrow Z1 indicates a direction toward an inner side in the axial direction (toward the inner pad 3 side with respect to the disc rotor 2). The arrow Z2 indicates a direction toward an outer side in the axial direction (toward the outer pad 4 side with respect to the disc rotor 2).

As shown in FIG. 3 and FIG. 4, the pad support member 10 has a first extended portion 11 and a second extended portion 12. The first extended portion 11 extends from a portion, fixed to the bracket 6, toward the outer side in the disc rotor radial direction. The second extended portion 12 extends from a predetermined portion of the first extended portion 11 toward both sides along the disc rotor tangential direction. The predetermined portion of the first extended portion 11 may be any portion in the first extended portion 11 as long as the portion is located on the outer side in the radial direction with respect to the portion fixed to the bracket 6. In the present embodiment, the predetermined portion of the first extended portion 11 is a radially outer side end of the first extended portion 11. The second extended portion 12 has an outer end face 12a and inner end faces 12b respectively on the outer side and inner side in the disc rotor radial direction. The outer end face 12a and the inner end faces 12b are flat faces perpendicular to the disc rotor radial direction. The second extended portion 12 further has a one-side end face 12c and an other-side end face 12d respectively on one side and the other side in the disc rotor tangential direction. The one-side end face 12c and the other-side end face 12d are flat faces perpendicular to the disc rotor tangential direction.

As shown in FIG. 3 and FIG. 5, the inner pad 3 includes a back plate 31 and a lining (friction material) 32. The lining 32 is fixedly connected to the back plate 31. The back plate 31 is made of a hard material having a high mechanical strength, for example, a metal, such as steel. Although the material of the lining 32 is not specifically limited, an example of the material of the lining 32 includes a mixture containing a fiber material, such as rock wool, Kevlar fiber and copper fiber, a binder, such as a resin, and a filler, such as barium sulfate, zirconium silicate, cashew dust and graphite. The back plate 31 of the inner pad 3 has a cutout 33 having a shape corresponding to the second extended portion 12. The cutout 33 has an outer opposing side face 33a and inner opposing side faces 33b respectively on the outer side and inner side in the disc rotor radial direction. The outer opposing side face 33a and the inner opposing side faces 33b are flat faces perpendicular to the disc rotor radial direction. The cutout 33 also has a one-side opposing side face 33c and an other-side opposing side face 33d respectively on one side and the other side in the disc rotor tangential direction. The one-side opposing side face 33c and the other-side opposing side face 33d are flat faces perpendicular to the disc rotor tangential direction. When the second extended portion 12 of the pad support member 10 has been fitted to the cutout 33 provided in the back plate 31 of the inner pad 3, the outer opposing side face 33a faces the outer end face 12a of the second extended portion 12, the inner opposing side faces 33b respectively face the inner end faces 12b of the second extended portion 12, the one-side opposing side face 33c faces the one-side end face 12c of the second extended portion 12, and the other-side opposing side face 33d faces the other-side end face 12d of the second extended portion 12.

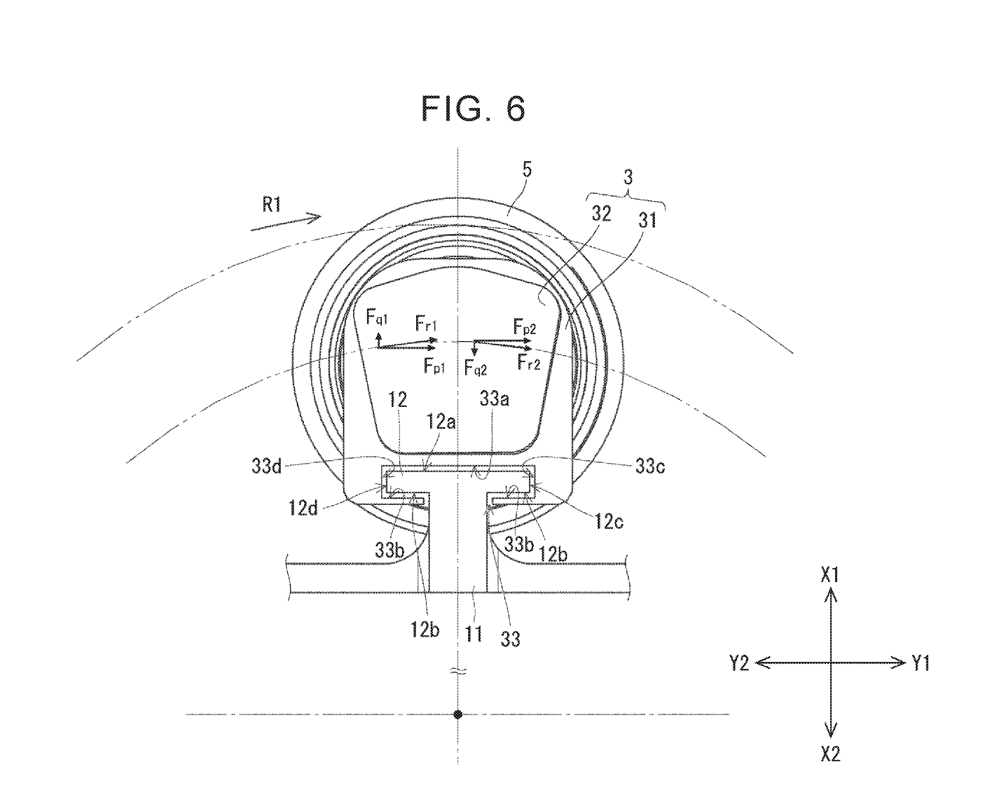

Next, how the rotation of the inner pad 3 is inhibited by the pad support member 10 at the time when the inner pad 3 has been brought into contact with the rotating disc rotor 2 will be described. FIG. 6 is a schematic view that illustrates forces exerted on the inner pad 3 at the time when the inner pad 3 has been brought into contact with the disc rotor 2 when the vehicle is moving forward, that is, when the disc rotor 2 is rotating in the forward direction. As shown in FIG. 6, when the inner pad 3 has been brought into contact with the disc rotor 2 that is rotating in the forward direction (rotating in the direction indicated by the arrow R1), forces Fr1, Fr2 in the disc rotor circumferential direction are exerted on the inner pad 3.

The force Fr1 in the disc rotor circumferential direction is allowed to be decomposed into a force Fp1 toward one side in the disc rotor tangential direction and a force Fq1 toward the outer side in the disc rotor radial direction. The force Fr2 in the disc rotor circumferential direction is allowed to be decomposed into a force Fp2 toward one side in the disc rotor tangential direction and a force Fq2 toward the inner side in the disc rotor radial direction. That is, the forces Fp1, Fp2 toward one side in the disc rotor tangential direction, the force Fq1 toward the outer side in the disc rotor radial direction and the force Fq2 toward the inner side in the disc rotor radial direction are exerted on the inner pad 3.

At the time when the inner pad 3 has been brought into contact with the rotating disc rotor 2, the second extended portion 12 of the pad support member 10 is fitted to the cutout 33 provided in the back plate 31 of the inner pad 3. Thus, the other-side opposing side face 33d in the cutout 33 of the inner pad 3 contacts the other-side end face 12d in the second extended portion 12, so the forces Fp1, Fp2 toward one side in the disc rotor tangential direction are born. The inner opposing side faces 33b in the cutout 33 of the inner pad 3 respectively contact the inner end faces 12b in the second extended portion 12, so the force Fq1 toward the outer side in the disc rotor radial direction is born. Furthermore, the outer opposing side face 33a in the cutout 33 of the inner pad 3 contacts the outer end face 12a in the second extended portion 12, so the force Fq2 toward the inner side in the disc rotor radial direction is born.

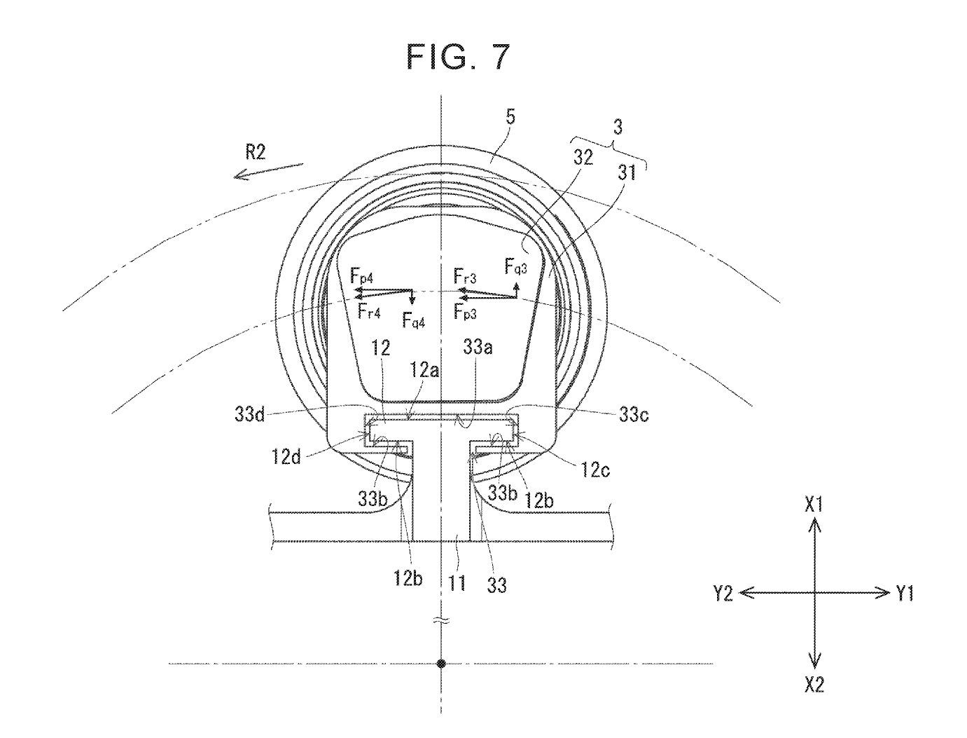

FIG. 7 is a schematic view that illustrates forces exerted on the inner pad 3 at the time when the inner pad 3 has been brought into contact with the disc rotor 2 when the vehicle is moving backward, that is, when the disc rotor 2 is rotating in the reverse direction. As shown in FIG. 7, when the inner pad 3 has been brought into contact with the disc rotor 2 rotating in the reverse direction (rotating in the direction indicated by the arrow R2), forces Fr3, Fr4 in the disc rotor circumferential direction are exerted on the inner pad 3.

The force Fr3 in the disc rotor circumferential direction is allowed to be decomposed into a force Fp3 toward the other side in the disc rotor tangential direction and a force Fq3 toward the outer side in the disc rotor radial direction. The force Fr4 in the disc rotor circumferential direction is allowed to be decomposed into a force Fp4 toward the other side in the disc rotor tangential direction and a force Fq4 toward the inner side in the disc rotor radial direction. That is, the forces Fp3, Fp4 toward the other side in the disc rotor tangential direction, the force Fq3 toward the outer side in the disc rotor radial direction and the force Fq4 toward the inner side in the disc rotor radial direction are exerted on the inner pad 3.

At the time when the inner pad 3 has been brought into contact with the rotating disc rotor 2, the second extended portion 12 of the pad support member 10 is fitted to the cutout 33 provided in the back plate 31 of the inner pad 3. Thus, the one-side opposing side face 33c in the cutout 33 of the inner pad 3 contacts the one-side end face 12c in the second extended portion 12, so the forces Fp3, Fp4 toward the other side in the disc rotor tangential direction are born. The inner opposing side faces 33b in the cutout 33 of the inner pad 3 respectively contact the inner end faces 12b in the second extended portion 12, so the force Fq3 toward the outer side in the disc rotor radial direction is born. The outer opposing side face 33a in the cutout 33 of the inner pad 3 contacts the outer end face 12a in the second extended portion 12, so the force Fq4 toward the inner side in the disc rotor radial direction is born.

As described above, in any case, that is, when the disc rotor 2 is rotating in the forward direction or when the disc rotor 2 is rotating in the reverse direction, it is possible to stably bear forces exerted on the inner pad 3 by the pad support member 10 at the time when the inner pad 3 has been brought into contact with the disc rotor 2, so it is possible to inhibit rotation of the inner pad 3. Thus, since the behavior of the inner pad 3 at the time when the inner pad 3 has been brought into contact with the rotating disc rotor 2 is stable, it is possible to improve noise vibration performance. Since the first extended portion 11 just needs to be extended from the portion fixed to the bracket 6 and the second extended portion 12 just needs to be extended from the first extended portion 11, an increase in the number of components is not required.

In a state where the inner pad 3 has not been brought into contact with the rotating disc rotor 2, the second extended portion 12 of the pad support member 10 may be fitted in advance to the cutout 33 provided in the back plate 31 of the inner pad 3. The cutout 33 is a cutout that extends through the back plate 31 in the axial direction. For this reason, when the inner pad 3 has been pressed by the piston 5, the inner pad 3 is allowed to move in the axial direction in a state where the cutout 33 and the second extended portion 12 remain fitted to each other, and contact the disc rotor 2. That is, when the inner pad 3 has been pressed by the piston 5, the inner pad 3 is guided by the second extended portion 12 to move in the axial direction. When the second extended portion 12 of the pad support member 10 is fitted in advance to the cutout 33 provided in the back plate 31 of the inner pad 3, the width of the second extended portion 12 in the axial direction needs to be larger than the width of the back plate 31 of the inner pad 3 in the axial direction.

### Second Embodiment

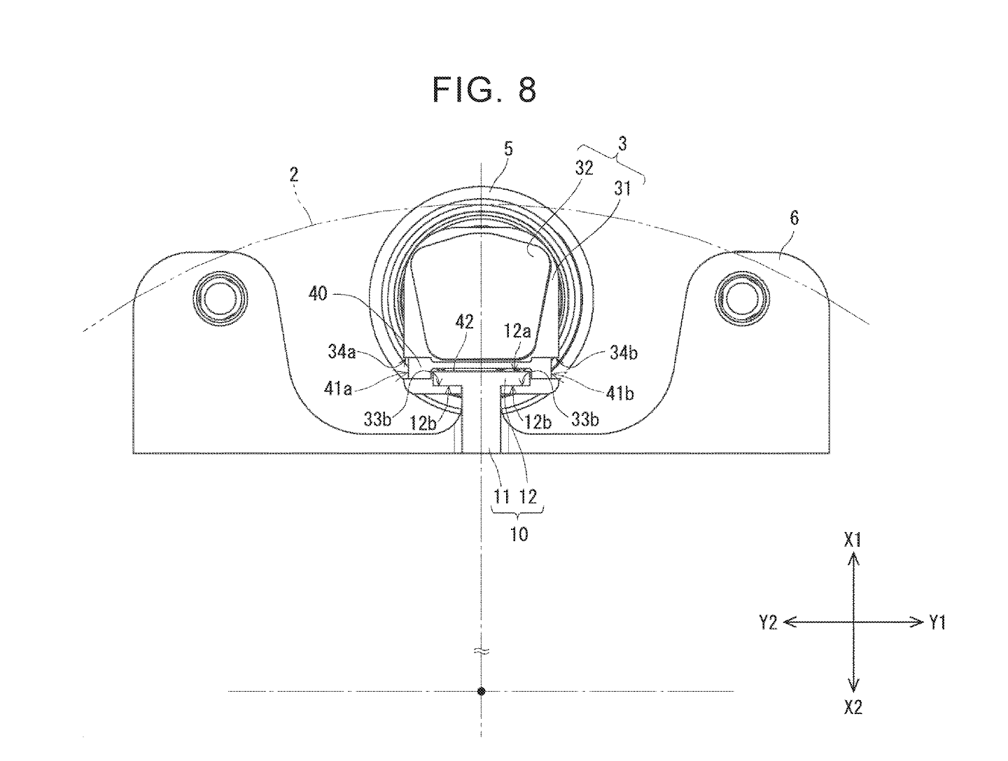

Hereinafter, a second embodiment of the disclosure will be described with reference to the accompanying drawings. Like reference numerals denote portions common to the first embodiment, and the description thereof is omitted. The basic configuration of a brake module according to the present embodiment is the same as the basic configuration of the brake module 1 according to the first embodiment described with reference to FIG. 1 and FIG. 2. FIG. 8 is a view, corresponding to FIG. 3 of the first embodiment, in the second embodiment. As shown in FIG. 8, the brake module according to the present embodiment differs from the brake module 1 according to the first embodiment in that a leaf spring 40 is further provided. The leaf spring 40 serves as an urging member that urges the inner pad 3 toward the inner side in the disc rotor radial direction such that the inner opposing side faces 33b of the cutout 33 respectively contact the inner end faces 12b of the second extended portion 12 on the inner side in the disc rotor radial direction.

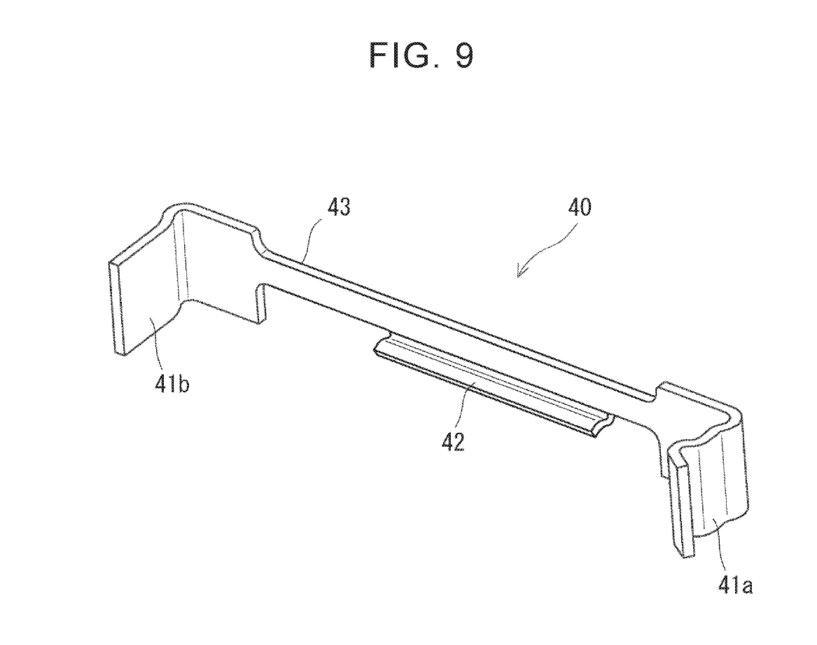

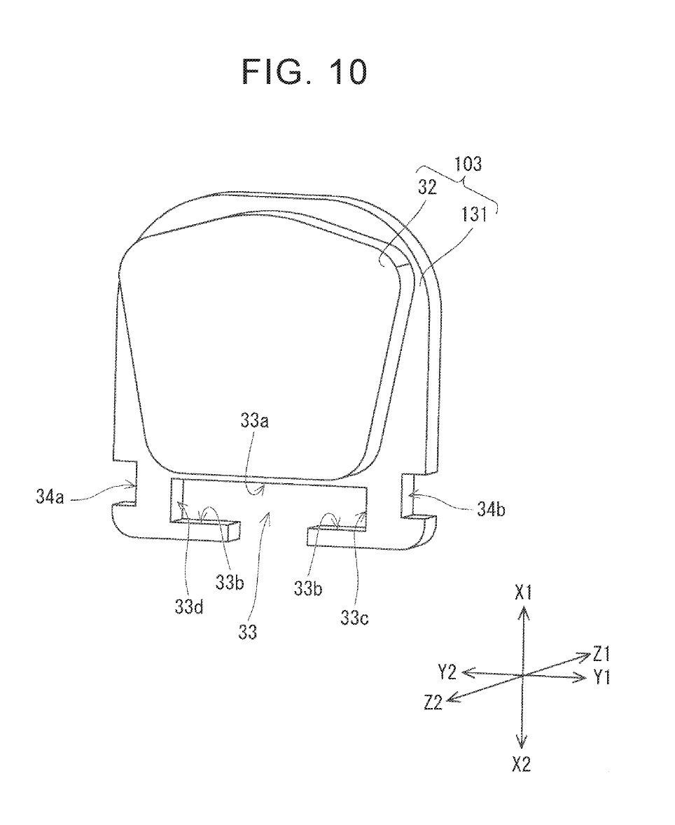

FIG. 9 is a view that shows the leaf spring 40 in the brake module. As shown in FIG. 9, the leaf spring 40 has pawls 41a, 41b and a spring portion 42. The pawls 41a, 41b are provided at both sides of a body portion 43 so as to form substantially a right angle with respect to the body portion 43. The spring portion 42 is provided at the center of the body portion 43 so as to form substantially a right angle with respect to the body portion 43. FIG. 10 is a perspective view that shows an inner pad 103 in the brake module. As shown in FIG. 10, constrictions 34a, 34b are respectively provided in the back plate 131 of the inner pad 103 at one side and the other side in the disc rotor tangential direction. The leaf spring 40 is, for example, made of stainless steel for a spring.

As shown in FIG. 8, by fitting the pawls 41a, 41b of the leaf spring 40 to the constrictions 34a, 34b of the back plate 31, the leaf spring 40 is fixed to the back plate 31. The spring portion 42 of the leaf spring 40 is inserted between the outer end face 12a of the second extended portion 12 and the outer opposing side face 33a that is a first side face of the cutout 33. The spring portion 42 of the leaf spring 40 contacts the outer end face 12a of the second extended portion 12 at its distal end, and urges the inner pad 3 toward the outer side in the disc rotor radial direction.

In a state where the second extended portion 12 is fitted to the cutout 33, there is a slight gap between the cutout 33 and the second extended portion 12. For this reason, at the time when the inner pad 3 has been brought into contact with the rotating disc rotor 2, the inner pad 3 can slightly rattle although the cutout 33 and the second extended portion 12 are fitted to each other. When the spring portion 42 of the leaf spring 40 urges the inner pad 3 toward the outer side in the disc rotor radial direction, the inner opposing side faces 33b that are second side faces in the cutout 33 of the inner pad 3 are constantly in contact with the inner end faces 12b of the second extended portion 12. Thus, it is possible to further improve noise vibration performance by further stabilizing the behavior of the pad at the time when the pad has been brought into contact with the rotating disc rotor.

The disclosure is not limited to the above-described embodiments. The above-described embodiments may be modified as needed without departing from the scope of the disclosure.

In the above-described embodiments, the second extended portion in the pad support member has a rectangular parallelepiped shape; however, the shape of the second extended portion is not limited to the rectangular parallelepiped shape. The second extended portion may have any shape as long as the second extended portion extends from the predetermined portion of the first extended portion toward both sides along the disc rotor tangential direction. The second extended portion may have, for example, a cylindrical columnar shape.

What is claimed is:

1. A brake module comprising:
a disc rotor rotatable about an axis of the disc rotor;
a pad arranged opposite the disc rotor in an axial direction of the disc rotor, the pad being configured to exert braking force at a time when the pad is in contact with the disc rotor;
a piston configured to bring the pad into contact with the disc rotor by pressing the pad;
a bracket supporting the piston such that the piston is movable in the axial direction; and
a pad support member supporting the pad such that the pad does not rotate at a time when the pad is brought into contact with the rotating disc rotor, wherein
the pad support member includes a first extended portion and a second extended portion, the first extended portion extends from a portion at which the first extended portion is fixed to the bracket, toward an outer side in a disc rotor radial direction, the second extended portion extends from a predetermined portion of the first extended portion toward both sides along a disc rotor tangential direction,
the pad has a cutout having a shape corresponding to the second extended portion, and
the second extended portion is configured to be fitted to the cutout at the time when the pad is brought into contact with the rotating disc rotor.

2. The brake module according to claim 1, further comprising:
an urging member inserted between an outer end face of the second extended portion on the outer side in the disc rotor radial direction and a first side face of the cutout, the urging member being configured to urge the pad toward the outer side in the disc rotor radial direction such that a second side face of the cutout contacts an inner end face of the second extended portion on an inner side in the disc rotor radial direction.
